(19) United States
(12) Patent Application Publication
(10) Pub. No.: US 2026/0277162 A1
(43) Pub. Date: Sep. 17, 2026

(54) TIMEPIECE

(71) Applicant: SEIKO WATCH KABUSHIKI KAISHA (trading as SEIKO WATCH CORPORATION), Tokyo (JP)

(72) Inventor: Katsunobu Iguchi, Tokyo (JP)

(21) Appl. No.: 19/544,479

(22) Filed: Feb. 19, 2026

(30) Foreign Application Priority Data
Mar. 13, 2025 (JP) 2025-039981

(51) Int. Cl. G04B 19/28; G04B 27/02

(52) U.S. Cl. CPC G04B 19/283; G04B 27/02

(57) ABSTRACT

An object is to reduce, in a timepiece including an operation portion that rotates an inner rotating ring only in one direction, a load applied to a component that transmits a torque of the operation portion to the inner rotating ring. A timepiece includes a timepiece case, an inner rotating ring that is accommodated in the timepiece case and that is rotatable in a second circumferential direction, an engagement gear that engages with the inner rotating ring and that rotates in synchronization with the inner rotating ring, a rotation operation portion that includes a head portion disposed outside the timepiece case and that is provided to be rotatable about an axis with respect to the timepiece case, and a rotation transmission portion that transmits clockwise rotation of the rotation operation portion to the engagement gear and that causes the rotation operation portion to idle counterclockwise.

### RELATED APPLICATIONS

This application claims priority to Japanese Patent application No. JP2025-039981 filed on Mar. 13, 2025, the entire content of which is incorporated herein by reference.

### BACKGROUND OF THE INVENTION

### 1. Field of the Invention

The present invention relates to a timepiece.

### 2. Description of the Related Art

There is a timepiece including an inner rotating ring rotatable along an outer peripheral edge of a dial (see, for example, JP2012-052919A). JP2012-052919A discloses a timepiece including: a rotatable operation member provided on a side portion of a wristwatch case so as to penetrate from an outside to an inside thereof; a gear provided on an inner end portion side of the operation member located in the wristwatch case and configured to rotate integrally with the operation member; a rotating ring provided in the wristwatch case so as to be rotatable along an inner peripheral surface thereof and configured to rotate in conjunction with rotation of the gear due to a rotation operation of the operation member; and a leaf spring-like elastic piece fixed to a case back and configured to elastically contact a tooth portion of the gear. In this timepiece, when the operation member is rotated, a rotational driving force is transmitted to the rotating ring, and the rotating ring rotates.

In the timepiece disclosed in JP2012-052919A, the gear and the elastic piece are formed such that the elastic piece is elastically deformed by the tooth portion of the gear to allow the operation member to rotate when the operation member rotates in one direction, and the elastic piece locks the tooth portion of the gear to prevent the rotation of the operation member when the operation member rotates in the other direction. Accordingly, when the operation member is rotated, tooth portions of the gear sequentially ride over the elastic piece, and thus a click feeling is given to the operation member.

However, in the configuration in which the inner rotating ring is set to be rotatable only in one direction by preventing the rotation of the operation member, there is a problem that a load is applied to a component or the like that transmits the torque of the operation member to the inner rotating ring when preventing the rotation of the operation member.

### SUMMARY OF THE INVENTION

It is an aspect of the present application to reduce, in a timepiece including an operation portion that rotates an inner rotating ring only in one direction, a load applied to a component that transmits a torque of the operation portion to the inner rotating ring.

A timepiece according to a first aspect of the present disclosure includes a case, an inner rotating ring that is accommodated in the case and that is rotatable in a circumferential direction, an engagement gear that is engaged with the inner rotating ring and that rotates in synchronization with the inner rotating ring, a rotation operation portion that includes a head portion disposed outside the case and that is provided to be rotatable about an axis with respect to the case, and a rotation transmission portion that transmits rotation of the rotation operation portion in a first direction to the engagement gear and that causes the rotation operation portion to idle in a second direction.

According to the first aspect, when a user rotates the rotation operation portion in the first direction, the inner rotating ring can be rotated through the rotation transmission portion and the engagement gear. On the other hand, when the user rotates the rotation operation portion in the second direction, the rotation operation portion idles, and thus the inner rotating ring does not rotate. Accordingly, it is possible to obtain a timepiece in which the inner rotating ring is rotatable only in one direction without preventing the rotation of the rotation operation portion. Therefore, it is possible to reduce the load applied to components that transmit the torque of the rotation operation portion to the inner rotating ring.

A timepiece according to a second aspect of the present disclosure is the timepiece according to the first aspect, in which the rotation transmission portion may include a driving ring that rotates in synchronization with the engagement gear about the axis, and a movable ring that is integrally rotatable with the rotation operation portion about the axis, that is integrally rotatable with the driving ring when rotating in the first direction, and that rotates in the second direction with respect to the driving ring when rotating in the second direction.

According to the second aspect, the rotation transmission portion transmits the rotation of the movable ring in the first direction to the driving ring and does not transmit the rotation of the movable ring in the second direction to the driving ring. Accordingly, the rotation transmission portion can transmit the rotation of the rotation operation portion in the first direction to the engagement gear and cause the rotation operation portion to idle in the second direction.

A timepiece according to a third aspect of the present disclosure is the timepiece according to the second aspect, in which the driving ring and the movable ring may be screwable to each other, and the movable ring may be screwed to the driving ring by rotating in the first direction with respect to the driving ring and then be not rotatable in the first direction with respect to the driving ring, and may be detached from the driving ring by rotating in the second direction with respect to the driving ring and then be rotatable in the second direction with respect to the driving ring.

According to the third aspect, the movable ring is integrally rotatable with the driving ring when rotating in the first direction, and rotates in the second direction with respect to the driving ring when rotating in the second direction. Accordingly, a timepiece having the above-described functions and effects is obtained.

A timepiece according to a fourth aspect of the present disclosure is the timepiece according to the second aspect, in which the driving ring may include a first engagement portion facing the movable ring in an axial direction of the axis, the movable ring may include a second engagement portion detachably engaged with the first engagement portion, and the first engagement portion and the second engagement portion may transmit rotation of the movable ring in the first direction to the driving ring when engaged with each other, and may be detached from each other by receiving rotation of the movable ring in the second direction with respect to the driving ring.

According to the fourth aspect, the movable ring is integrally rotatable with the driving ring when rotating in the first direction, and rotates in the second direction with respect to the driving ring when rotating in the second direction. Accordingly, a timepiece having the above-described functions and effects is obtained.

A timepiece according to a fifth aspect of the present disclosure is the timepiece according to any one of the first aspect to the fourth aspect, further including a thread portion that is disposed outside the case and that is fixed to the case, in which the head portion may be screwed to the thread portion and detached from the thread portion by rotating in the first direction with respect to the case.

According to the fifth aspect, since the inner rotating ring can be rotated in the process of releasing the screwing between the head portion and the thread portion, it is possible to quickly start rotating the inner rotating ring. In addition, since the inner rotating ring does not rotate when screwing the head portion to the thread portion, the inner rotating ring can be reliably stopped at a desired rotation position.

A timepiece according to a sixth aspect of the present disclosure is the timepiece according to any one of the first to fifth aspects, further including a resistance member that comes into sliding contact with the inner rotating ring to apply resistance to rotation of the inner rotating ring with respect to the case.

According to the sixth aspect, since the resistance member makes it difficult for the inner rotating ring to rotate, even if the rotation transmission portion transmits a part of the torque of the rotation operation portion in the second direction to the engagement gear due to frictional resistance or the like between the components, it is possible to prevent the inner rotating ring from rotating in a restricted rotation direction.

A timepiece according to a seventh aspect of the present disclosure is the timepiece according to the sixth aspect, in which the inner rotating ring may be formed with a plurality of recesses and projections arranged in the circumferential direction, and the resistance member may be engaged with and disengaged from the recess and projection while being elastically deformed.

According to the seventh aspect, when rotating the rotation operation portion, locking and release of locking between the recess and projection of the inner rotating ring and the resistance member occur, and thus the user who operates the rotation operation portion obtains a click feeling. Therefore, the operation feeling brought by the rotation operation portion is improved. Furthermore, resistance is generated in the rotation of the inner rotating ring with respect to the case by the locking between the recess and projection of the inner rotating ring and the resistance member. Therefore, a resistance member that applies resistance to the rotation of the inner rotating ring with respect to the case is obtained.

A timepiece according to an eighth aspect of the present disclosure is the timepiece according to any one of the first to seventh aspects, in which the case may include a facing portion that faces the inner rotating ring over the entire circumferential direction, and the resistance member may be a gasket that is in close contact with the facing portion and the inner rotating ring over an entire circumference.

According to the eighth aspect, since frictional resistance is generated between the gasket and the facing portion and between the gasket and the inner rotating ring, the resistance member that applies the frictional resistance to the rotation of the inner rotating ring with respect to the case is obtained.

A timepiece according to a ninth aspect of the present disclosure is the timepiece according to any one of the first to eighth aspects, in which the rotation operation portion may include a shaft portion that extends from the head portion toward an inside of the case and that engages with the rotation transmission portion, and the shaft portion and the head portion may be integrally formed.

According to the ninth aspect, the number of components can be reduced as compared with a configuration in which the shaft portion and the head portion are provided as separate members. Further, since loosening of the screwing between the shaft portion and the head portion due to the rotation operation of the rotation operation portion does not occur, it is possible to provide a timepiece having excellent durability.

According to the application, in a timepiece including an operation portion that rotates an inner rotating ring only in one direction, a load applied to a component that transmits a torque of the operation portion to the inner rotating ring can be reduced.

### BRIEF DESCRIPTION OF THE DRAWINGS

FIG. 1 is a plan view illustrating a timepiece according to a first embodiment.

FIG. 2 is a cross-sectional view taken along a line II-II in FIG. 1.

FIG. 3 is an enlarged view of a portion III in FIG. 2.

FIG. 4 is an exploded perspective view illustrating a part of the timepiece according to the first embodiment.

FIG. 5 is an exploded perspective view illustrating a part of a ring driving portion according to the first embodiment.

FIG. 6 is a cross sectional view of the timepiece according to the first embodiment and corresponds to FIG. 3.

FIG. 7 is a cross-sectional view of a timepiece according to a modification of the first embodiment and corresponds to FIG. 3.

FIG. 8 is a cross-sectional view illustrating a part of a timepiece according to a second embodiment and corresponds to FIG. 3.

FIG. 9 is an exploded perspective view illustrating a part of the timepiece according to the second embodiment.

FIG. 10 is a longitudinal cross-sectional view of a rotation transmission portion according to the second embodiment.

FIG. 11 is an exploded perspective view illustrating a part of a ring driving portion according to the second embodiment.

FIG. 12 is a cross-sectional view of the timepiece according to the second embodiment and corresponds to FIG. 8.

### DETAILED DESCRIPTION OF THE PREFERRED EMBODIMENTS

Hereinafter, an embodiment of the invention will be described with reference to the drawings. In the following description, configurations having the same or similar functions are denoted by the same reference signs. A duplicate description of these configurations may be omitted.

### First Embodiment

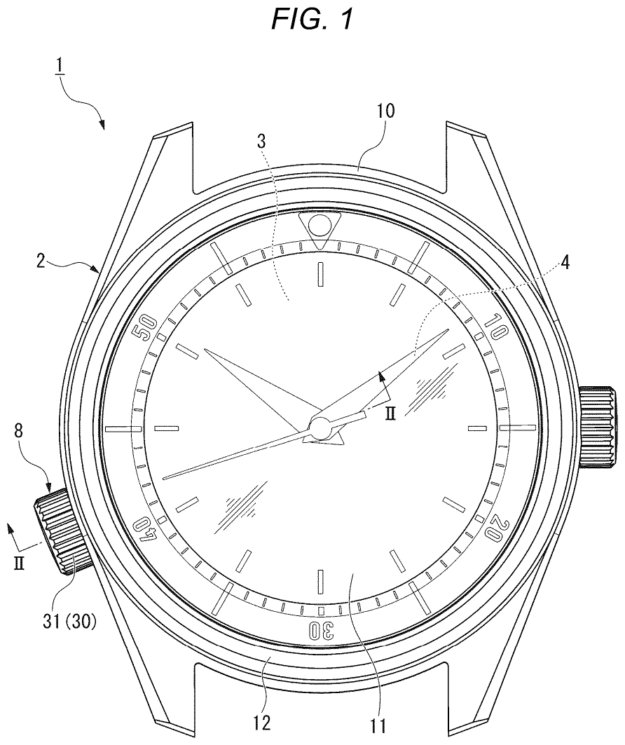

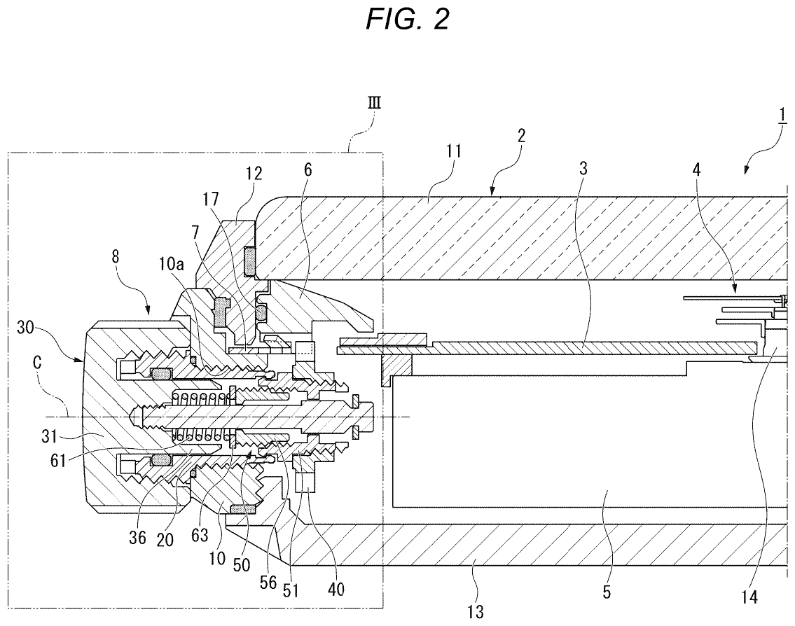

FIG. 1 is a plan view illustrating a timepiece according to a first embodiment. FIG. 2 is a cross-sectional view taken along a line II-II in FIG. 1.

As illustrated in FIGS. 1 and 2, a timepiece 1 according to the first embodiment mainly includes a timepiece case (case) 2, a dial 3, a hand 4, a movement 5, an inner rotating ring 6, a click spring 7, and a ring driving portion 8. In the embodiment, a rotation axis direction of the hand 4 is referred to as an up-down direction (timepiece front-back direction).

The timepiece case 2 accommodates the dial 3, the hand 4, the movement 5, the inner rotating ring 6, the click spring 7, and the like. The timepiece case 2 includes a case main body 10, a windshield 11, a bezel (facing portion) 12, and a case back 13. The case main body 10 is formed in a cylindrical shape that is open in the up-down direction. The windshield 11 closes one opening of the case main body 10. The case back 13 closes the other opening of the case main body 10. Hereinafter, in the embodiment, in the up-down direction, a direction from the case back 13 toward the windshield 11 is described as an upper side, and an opposite side thereof is described as a lower side.

An operation hole 10a is formed in the case main body 10. The operation hole 10a penetrates the case main body 10 along a main radial direction. The “main radial direction” is a direction orthogonal to the rotation axis of the hand 4 and extending in a radial direction from the rotation axis. A female thread is formed on an inner wall surface of the operation hole 10a.

The bezel 12 is formed in a cylindrical shape that is open in the up-down direction. The bezel 12 is fitted into an upper end opening of the case main body 10. An upper half of the bezel 12 surrounds the windshield 11 over the entire circumference thereof and holds an outer peripheral portion of the windshield 11. A lower half of the bezel 12 surrounds the inner rotating ring 6 over the entire circumference thereof.

The dial 3 is formed in a circular plate shape. The dial 3 is visible through the windshield 11. The hand 4 is disposed between the dial 3 and the windshield 11. The hand 4 is attached to a rotation shaft 14 of the movement 5. The movement 5 is disposed between the dial 3 and the case back 13. The movement 5 includes a drive source that drives the rotation shaft 14 and the like.

The inner rotating ring 6 is formed in a circular ring shape about the rotation axis of the hand 4. The inner rotating ring 6 extends along an outer peripheral edge of the dial 3. The inner rotating ring 6 is rotatable in a first circumferential direction. The “first circumferential direction” is a direction around the rotation axis of the hand 4.

The inner rotating ring 6 is located on an inner side of the lower half of the bezel 12 and below the windshield 11. The inner rotating ring 6 includes an information display surface and an outer peripheral surface. The information display surface is an upper surface of the inner rotating ring 6. The information display surface is an inclined surface that descends inward in the main radial direction. Information display can be formed on the information display surface by characters, symbols, graphics, or the like. In the embodiment, the inner rotating ring 6 is a reverse rotation preventing bezel provided in a so-called diver's watch or the like. The outer peripheral surface faces an inner peripheral surface of the lower half of the bezel 12 in the main radial direction over the entire circumference. A gasket 17 in a circular ring shape is sandwiched between the outer peripheral surface and the inner peripheral surface of the lower half of the bezel 12. The gasket 17 is in close contact with the inner rotating ring 6 and the inner peripheral surface of the lower half of the bezel 12 over the entire circumference. The gasket 17 is an example of a “resistance member” that comes into sliding contact with the inner rotating ring 6 to apply frictional resistance to the rotation of the inner rotating ring 6 with respect to the timepiece case 2.

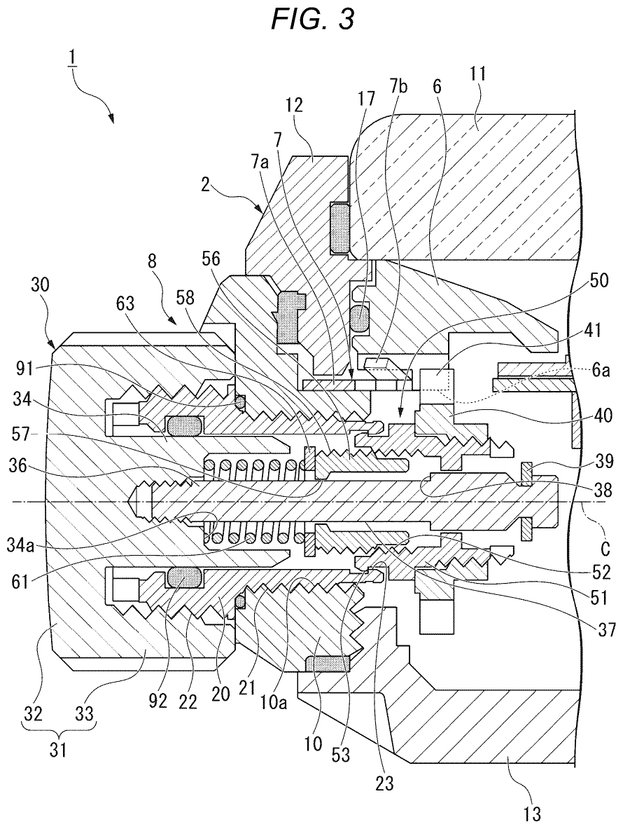

FIG. 3 is an enlarged view of a portion III in FIG. 2.

As illustrated in FIG. 3, a plurality of tooth portions (recesses and projections) 6a arranged in the first circumferential direction are formed on a lower surface (a surface on the case back 13 side) of the inner rotating ring 6. The tooth portions 6a protrude downward from the lower surface of the inner rotating ring 6.

The click spring 7 is formed in a circular ring shape and is disposed coaxially with the inner rotating ring 6. The click spring 7 is disposed below the inner rotating ring 6. The click spring 7 is a metal thin plate having a thickness in the up-down direction. The click spring 7 is an example of a “resistance member” that comes into sliding contact with the inner rotating ring 6 to apply resistance to the rotation of the inner rotating ring 6 with respect to the timepiece case 2. The click spring 7 includes a base portion 7a in a circular ring shape and an extending portion 7b extending upward from the base portion 7a. The base portion 7a is fixed to the case main body 10. The base portion 7a includes an outer peripheral portion sandwiched between the case main body 10 and the bezel 12 in the up-down direction and an inner peripheral portion facing the inner rotating ring 6 in the up-down direction. The extending portion 7b extends upward from the inner peripheral portion and to one side in the first circumferential direction. In the embodiment, the one side in the first circumferential direction is a counterclockwise direction when viewed from above. The extending portion 7b enters a tooth groove of the tooth portion 6a of the inner rotating ring 6. The extending portion 7b can ride over the tooth portion 6a of the inner rotating ring 6 to the other side in the first circumferential direction while being elastically deformed downward. That is, when the inner rotating ring 6 rotates to the one side in the first circumferential direction, the extending portion 7b is engaged with and disengaged from the tooth portion 6a while being elastically deformed. On the other hand, the extending portion 7b cannot ride over the tooth portion 6a to the one side in the first circumferential direction since a tip end edge thereof is caught by the tooth portion 6a. Therefore, the click spring 7 allows rotation of the inner rotating ring 6 to the one side in the first circumferential direction and restricts the rotation to the other side in the first circumferential direction. Further, the click spring 7 elastically deforms the extending portion 7b each time the tooth portion 6a rides over the extending portion 7b, thereby increasing or decreasing rotational resistance generated in the inner rotating ring 6. That is, the click spring 7 generates a click feeling every time the inner rotating ring 6 rotates by a predetermined angle to the one side in the first circumferential direction.

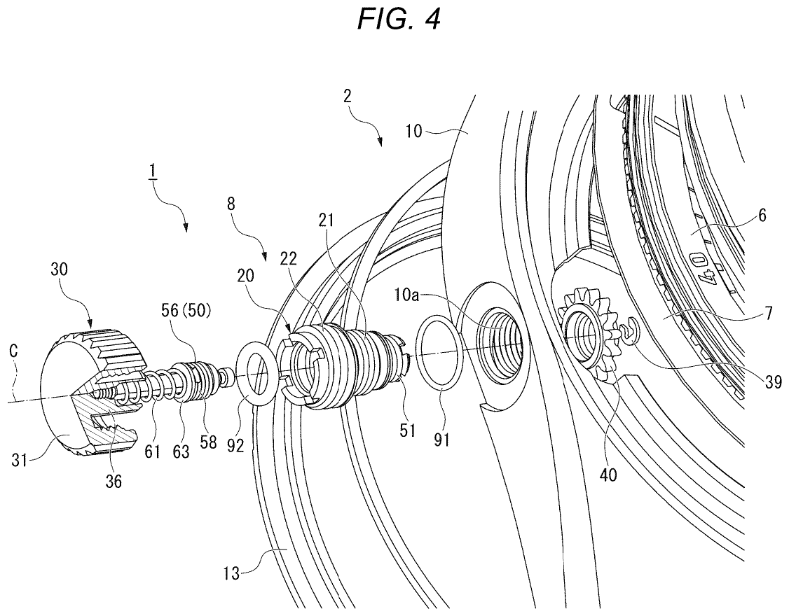

FIG. 4 is an exploded perspective view illustrating a part of the timepiece according to the first embodiment.

As illustrated in FIGS. 3 and 4, the ring driving portion 8 includes a support cylinder 20, a rotation operation portion 30, an engagement gear 40, and a rotation transmission portion 50.

The support cylinder 20 is fixed to the operation hole 10a of the case main body 10. The support cylinder 20 is formed in a cylindrical shape centered on an axis C passing through the operation hole 10a of the case main body 10. Hereinafter, a direction around the axis C is referred to as a “second circumferential direction”, and a direction in which the axis C extends is simply referred to as an “axial direction”. Further, in the axial direction, a direction from the outside to the inside of the case main body 10 is referred to as an “inward side”, and a direction from the inside to the outside of the case main body 10 is referred to as an “outward side”. The support cylinder 20 is disposed so as to protrude outward in the axial direction from the case main body 10.

An inner male thread portion 21 and an outer male thread portion (thread portion) 22 are formed on an outer peripheral surface of the support cylinder 20. The inner male thread portion 21 is screwed into the female thread of the operation hole 10a of the case main body 10. The support cylinder 20 is fixed to the operation hole 10a by screwing between the inner male thread portion 21 and the female thread of the operation hole 10a. The outer male thread portion 22 is formed on the outer side of the inner male thread portion 21 in the axial direction and is located outside the case main body 10. The outer male thread portion 22 has reverse threads (left-hand threads). An engaging protrusion 23 is formed at an axially inner end portion of the support cylinder 20, protrudes inward in the radial direction and extends over the entire second circumferential direction. A seal member 91 in a ring shape is interposed between the support cylinder 20 and the case main body 10. The seal member 91 is in close contact with a portion of the outer peripheral surface of the support cylinder 20 between the inner male thread portion 21 and the outer male thread portion 22. The seal member 91 blocks communication between the inside and the outside of the case main body 10 through a space between the outer peripheral surface of the support cylinder 20 and the inner wall surface of the operation hole 10a of the case main body 10.

The rotation operation portion 30 is provided to be rotatable about the axis C with respect to the case main body 10. Further, the rotation operation portion 30 is movable along the axial direction between a push-in position where the rotation operation portion 30 is pushed inward in the axial direction toward the inside of the case main body 10 and a pull-out position where the rotation operation portion 30 is pulled outward in the axial direction toward the outside of the case main body 10. In the following description, it is assumed that the rotation operation portion 30 is at the push-in position unless otherwise specified.

The rotation operation portion 30 includes a head portion 31 and a shaft portion 36. The head portion 31 is disposed outside the case main body 10. The head portion 31 is formed in a topped cylindrical shape centered on the axis C. The head portion 31 includes a top wall portion 32 extending in a direction orthogonal to the axial direction, a peripheral wall portion 33 extending inward in the axial direction from an outer peripheral edge of the top wall portion 32, and an inner cylindrical portion 34 extending inward in the axial direction from the top wall portion 32 beyond the peripheral wall portion 33 on an inner side thereof.

An inner peripheral surface of the peripheral wall portion 33 is formed with a female thread portion screwed to the outer male thread portion 22 of the support cylinder 20. The peripheral wall portion 33 is detachably screwed to the support cylinder 20 by screwing between the female thread portion and the outer male thread portion 22. An axially inner end portion of the peripheral wall portion 33 abuts an outer peripheral surface of the case main body 10. The rotation operation portion 30 is completely screwed to the support cylinder 20 at the push-in position and cannot rotate counterclockwise. The rotation operation portion 30 moves outward in the axial direction from the push-in position toward the pull-out position by rotating clockwise so as to release the screwing with respect to the support cylinder 20. The rotation operation portion 30 is completely detached from the support cylinder 20 when being at the pull-out position. In the embodiment, rotation directions (counterclockwise and clockwise) around the axis C are directions when viewed from the outer side in the axial direction.

The inner cylindrical portion 34 is formed in a cylindrical shape centered on the axis C. The inner cylindrical portion 34 extends inward in the axial direction from the top wall portion 32 beyond the support cylinder 20 on the inner side. A stepped surface 34a facing inward in the axial direction and extending over the entire second circumferential direction is formed on an inner peripheral surface of the inner cylindrical portion 34. A seal member 92 in a ring shape is interposed between an outer peripheral surface of the inner cylindrical portion 34 and an inner peripheral surface of the support cylinder 20. The seal member 92 is in close contact with the outer peripheral surface of the inner cylindrical portion 34 and the inner peripheral surface of the support cylinder 20 over the entire circumference. The inner cylindrical portion 34 is slidable in the axial direction with respect to the seal member 92.

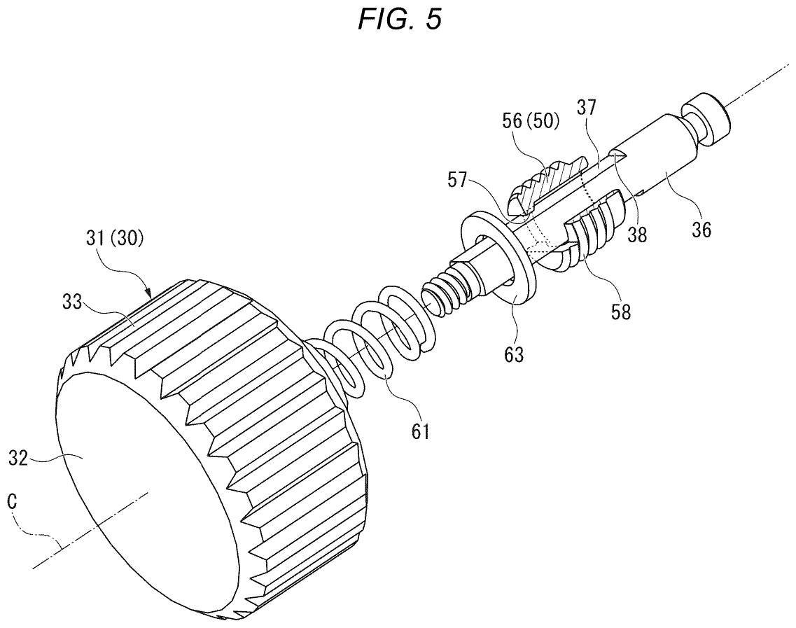

FIG. 5 is an exploded perspective view illustrating a part of the ring driving portion according to the first embodiment.

As illustrated in FIGS. 3 and 5, the shaft portion 36 extends inward in the axial direction from the head portion 31, with the axis C being a center. An axially outer end portion of the shaft portion 36 is inserted into the inner cylindrical portion 34 beyond the stepped surface 34a of the inner cylindrical portion 34 on the inner side of the stepped surface 34a. The axially outer end portion of the shaft portion 36 is screwed to the inner cylindrical portion 34. Accordingly, the shaft portion 36 and the head portion 31 are fixed to each other. An outer peripheral surface of the shaft portion 36 includes a flat surface portion 37 and a step portion 38. The flat surface portion 37 is formed by surface cutting and extends along the axial direction. The step portion 38 is connected to an axially inner end edge of the flat surface portion 37 and faces outward in the axial direction. A retaining ring 39 is attached to an axially inner end portion of the shaft portion 36.

As illustrated in FIG. 3, the engagement gear 40 is disposed on the inner side of the case main body 10. The engagement gear 40 is disposed coaxially with the axis C. The engagement gear 40 is formed in a circular ring shape. The shaft portion 36 of the rotation operation portion 30 is inserted into the engagement gear 40. The engagement gear 40 is rotatably supported by the shaft portion 36 via a driving ring 51 described later. The engagement gear 40 includes a plurality of driving teeth 41 arranged at equal intervals in the second circumferential direction. The driving teeth 41 mesh with the tooth portions 6a of the inner rotating ring 6. The engagement gear 40 transmits rotation of the driving ring 51 to the inner rotating ring 6 by the meshing between the driving teeth 41 and the tooth portions 6a, and rotates the inner rotating ring 6 in the first circumferential direction.

The rotation transmission portion 50 transmits clockwise (first direction) rotation of the rotation operation portion 30 to the engagement gear 40, and causes the rotation operation portion 30 to idle counterclockwise (second direction) with respect to the engagement gear 40. The rotation operation portion 30 includes the driving ring 51, a movable ring 56, a coil spring 61, and a washer 63.

The driving ring 51 is disposed coaxially with the axis C. The driving ring 51 is formed in a cylindrical shape. The driving ring 51 is inserted into the engagement gear 40. The driving ring 51 is screwed to the engagement gear 40. The driving ring 51 is fixed to the engagement gear 40, thereby rotating in synchronization with the engagement gear 40. The shaft portion 36 of the rotation operation portion 30 is inserted into the driving ring 51. The driving ring 51 is movable in the axial direction and rotatable with respect to the shaft portion 36. The retaining ring 39 can contact the driving ring 51 from the inner side in the axial direction. When the retaining ring 39 comes into contact with the driving ring 51, an axially outward movement of the rotation operation portion 30 with respect to the driving ring 51 is restricted. For example, the retaining ring 39 comes into contact with the driving ring 51 in a state where the rotation operation portion 30 is at the pull-out position.

The driving ring 51 protrudes further outward in the axial direction than the engagement gear 40. An axially outer end portion of the driving ring 51 is inserted into the support cylinder 20. An engaged protrusion 53 is formed at an axially outer end portion of the driving ring 51, protrudes outward in the radial direction and extends over the entire second circumferential direction. The engaged protrusion 53 engages with the engaging protrusion 23 of the support cylinder 20 from the outer side in the axial direction. By the engagement of the engaged protrusion 53 and the engaging protrusion 23, the driving ring 51 is fitted to the support cylinder 20 in a relatively rotatable state. A female thread portion 52 is formed on an inner peripheral surface of the driving ring 51. The female thread portion 52 has regular threads (right-hand threads).

The movable ring 56 is disposed coaxially with the axis C. The movable ring 56 is formed in a cylindrical shape. The movable ring 56 is disposed on an outer side (outer side in the axial direction) of the case main body 10 with respect to the driving ring 51. The shaft portion 36 of the rotation operation portion 30 is inserted into the movable ring 56. The movable ring 56 is movable in the axial direction with respect to the shaft portion 36. The movable ring 56 has a rotation restriction protrusion 57 protruding inward in the radial direction. The rotation restriction protrusion 57 faces the flat surface portion 37 of the shaft portion 36 regardless of the position of the rotation operation portion 30, and restricts the rotation of the movable ring 56 with respect to the shaft portion 36 by engaging with the flat surface portion 37. Accordingly, the movable ring 56 is integrally rotatable with the rotation operation portion 30. The rotation restriction protrusion 57 can abut the step portion 38 of the shaft portion 36 from the outer side in the axial direction.

A male thread portion 58 that can be screwed into the female thread portion 52 of the driving ring 51 is formed on an outer peripheral surface of the movable ring 56. Accordingly, the movable ring 56 and the driving ring 51 can be screwed together. The movable ring 56 cannot rotate clockwise with respect to the driving ring 51 when screwed to the driving ring 51, and can rotate clockwise integrally with the driving ring 51. When rotating counterclockwise, the movable ring 56 rotates counterclockwise with respect to the driving ring 51 while being unscrewed from the driving ring 51, and is detached from the driving ring 51.

The coil spring 61 biases the movable ring 56 toward the driving ring 51 along the axial direction (inward in the axial direction). The shaft portion 36 of the rotation operation portion 30 is inserted into the coil spring 61. The coil spring 61 is interposed in a compressed state between the stepped surface 34a of the rotation operation portion 30 and an axially outer end surface of the movable ring 56. The washer 63 in a circular ring shape is interposed between the coil spring 61 and the movable ring 56. The coil spring 61 biases the movable ring 56 inward in the axial direction with respect to the rotation operation portion 30.

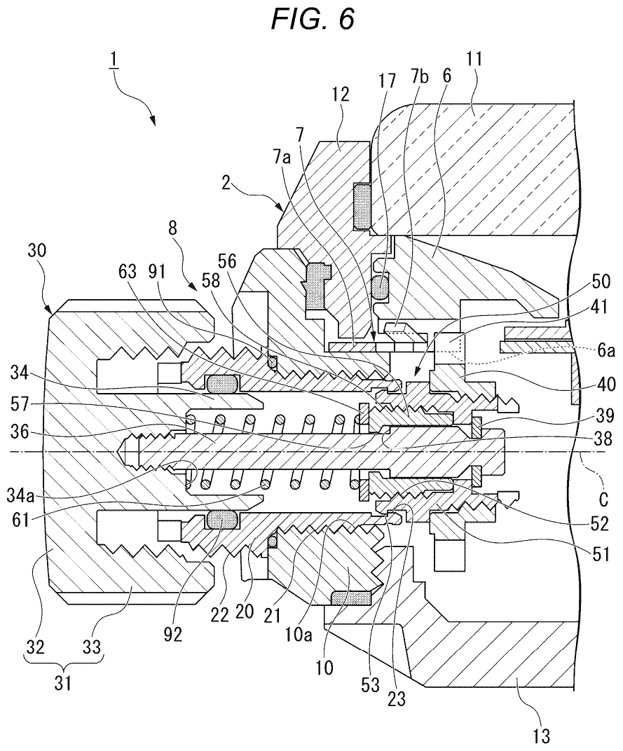

An operation of the timepiece 1 according to the embodiment will be described with reference to FIGS. 3 and 6. FIG. 6 is a cross-sectional view of the timepiece 1 according to the first embodiment and corresponds to FIG. 3. FIG. 3 illustrates a state in which the rotation operation portion 30 is at the push-in position, and FIG. 6 illustrates a state in which the rotation operation portion 30 is at the pull-out position.

When the rotation operation portion 30 at the push-in position is rotated clockwise, the screwing of the head portion 31 and the support cylinder 20 is loosened, and the head portion 31 is detached from the support cylinder 20 and moves to the pull-out position. When the rotation operation portion 30 is rotated clockwise, the movable ring 56 of the rotation transmission portion 50 also rotates clockwise. Here, since the driving ring 51 can rotate in synchronization with the inner rotating ring 6 via the engagement gear 40 and the rotational resistance is applied to the inner rotating ring 6, the driving ring 51 is restricted from rotating and is substantially stopped. Further, the movable ring 56 is biased toward the driving ring 51 by the coil spring 61. Therefore, when the movable ring 56 is rotated clockwise, the movable ring 56 is screwed into the driving ring 51.

When the movable ring 56 is completely screwed into the driving ring 51, the driving ring 51 rotates clockwise integrally with the movable ring 56. The movable ring 56 may be completely screwed into the driving ring 51 after the head portion 31 is detached from the support cylinder 20, or the movable ring 56 may be completely screwed into the driving ring 51 before the head portion 31 is detached from the support cylinder 20. In the process of screwing the movable ring 56 into the driving ring 51, the driving ring 51 may be rotated together by the frictional resistance generated between the movable ring 56 and the driving ring 51. When the driving ring 51 rotates clockwise, the engagement gear 40 fixed to the driving ring 51 also rotates clockwise, and further the inner rotating ring 6 rotates counterclockwise. In the embodiment, the rotation directions (clockwise direction, counterclockwise direction) of the inner rotating ring 6 are the directions when viewed from above. Therefore, when the rotation operation portion 30 is rotated clockwise, the torque is transmitted to the inner rotating ring 6 through the rotation transmission portion 50 and the engagement gear 40, and the inner rotating ring 6 rotates counterclockwise.

When the rotation operation portion 30 at the pull-out position is rotated counterclockwise while being pushed inward in the axial direction, the head portion 31 is screwed into the support cylinder 20 and moves to the push-in position. When the rotation operation portion 30 is rotated counterclockwise, the movable ring 56 is also rotated counterclockwise. Since the rotation of the inner rotating ring 6 in the clockwise direction is restricted, the rotation of the driving ring 51 in the counterclockwise direction is restricted. Therefore, in a case where the movable ring 56 is screwed into the driving ring 51, when the movable ring 56 rotates counterclockwise, the screwing between the movable ring 56 and the driving ring 51 is loosened and released. When the screwing between the movable ring 56 and the driving ring 51 is released, the movable ring 56 simply idles counterclockwise with respect to the driving ring 51. Therefore, the rotation operation portion 30 idles counterclockwise with respect to the engagement gear 40 without rotating the inner rotating ring 6.

As described above, the rotation transmission portion 50 transmits the clockwise rotation of the rotation operation portion 30 to the engagement gear 40, and causes the rotation operation portion 30 to idle counterclockwise without rotating the engagement gear 40. As a result, in the timepiece 1 according to the embodiment, only the torque in one direction (clockwise direction) of the rotation operation portion 30 is transmitted to the inner rotating ring 6, and the inner rotating ring 6 can be rotated only counterclockwise.

As described above, the timepiece 1 according to the embodiment includes the inner rotating ring 6 that is accommodated in the timepiece case 2 and is rotatable in the second circumferential direction, the engagement gear 40 that engages with the inner rotating ring 6 and rotates in synchronization with the inner rotating ring 6, the rotation operation portion 30 that is provided to be rotatable about the axis C with respect to the timepiece case 2, and the rotation transmission portion 50 that transmits the clockwise rotation of the rotation operation portion 30 to the engagement gear 40 and causes the rotation operation portion 30 to idle counterclockwise. According to this configuration, when the user rotates the rotation operation portion 30 clockwise, the inner rotating ring 6 can be rotated through the rotation transmission portion 50 and the engagement gear 40. On the other hand, when the user rotates the rotation operation portion 30 counterclockwise, the rotation operation portion 30 idles, and thus the inner rotating ring 6 does not rotate. Accordingly, the timepiece 1 in which the inner rotating ring 6 is rotatable only in one direction without preventing the rotation of the rotation operation portion 30 is obtained. Therefore, it is possible to reduce the load applied to components that transmit the torque of the rotation operation portion 30 to the inner rotating ring 6.

The rotation transmission portion 50 includes the driving ring 51 that rotates in synchronization with the engagement gear 40 about the axis C, and the movable ring 56 that is integrally rotatable with the rotation operation portion 30 about the axis C, is integrally rotatable with the driving ring 51 when rotating clockwise, and rotates counterclockwise with respect to the driving ring 51 when rotating counterclockwise. According to this configuration, the rotation transmission portion 50 transmits the clockwise rotation of the movable ring 56 to the driving ring 51, and does not transmit the counterclockwise rotation of the movable ring 56 to the driving ring 51. Accordingly, the rotation transmission portion 50 can transmit the clockwise rotation of the rotation operation portion 30 to the engagement gear 40 and cause the rotation operation portion 30 to idle counterclockwise.

The driving ring 51 and the movable ring 56 can be screwed together. The movable ring 56 is screwed to the driving ring 51 by rotating clockwise with respect to the driving ring 51 and then cannot rotate clockwise with respect to the driving ring 51, and the movable ring 56 is detached from the driving ring 51 by rotating counterclockwise with respect to the driving ring 51 and then can rotate counterclockwise relative to the driving ring 51. According to this configuration, the movable ring 56 can rotate integrally with the driving ring 51 when rotating clockwise, and rotates counterclockwise with respect to the driving ring 51 when rotating counterclockwise. Accordingly, the timepiece 1 having the above-described functions and effects is obtained.

The timepiece 1 further includes the outer male thread portion 22 provided outside the timepiece case 2 and fixed to the timepiece case 2. The head portion 31 is screwed to the outer male thread portion 22 and is detached from the outer male thread portion 22 by rotating clockwise with respect to the timepiece case 2. According to this configuration, since the inner rotating ring 6 can be rotated in the process of releasing the screwing between the head portion 31 and the outer male thread portion 22, it is possible to quickly start rotating the inner rotating ring 6. In addition, since the inner rotating ring 6 does not rotate when screwing the head portion 31 to the outer male thread portion 22, the inner rotating ring 6 can be reliably stopped at a desired rotation position.

The timepiece 1 includes a resistance member (the gasket 17 and the click spring 7) that comes into sliding contact with the inner rotating ring 6 to apply resistance to the rotation of the inner rotating ring 6 with respect to the timepiece case 2. According to this configuration, since the resistance member makes it difficult for the inner rotating ring 6 to rotate, even if the rotation transmission portion 50 transmits a part of a counterclockwise torque of the rotation operation portion 30 to the engagement gear 40 due to frictional resistance or the like between the components, it is possible to restrict the inner rotating ring 6 from rotating in a restricted rotation direction (clockwise direction).

The inner rotating ring 6 is formed with a plurality of tooth portions 6a arranged side by side in the second circumferential direction. The click spring 7 is engaged with and disengaged from the tooth portions 6a while being elastically deformed. According to this configuration, when rotating the rotation operation portion 30, locking and release of locking between the tooth portions 6a of the inner rotating ring 6 and the click spring 7 occur, and thus the user who operates the rotation operation portion 30 obtains a click feeling. Therefore, an operation feeling brought by the rotation operation portion 30 is improved. Further, resistance is generated in the rotation of the inner rotating ring 6 with respect to the timepiece case 2 by the locking between the tooth portions 6a of the inner rotating ring 6 and the click spring 7. Therefore, the click spring 7 can be a resistance member that applies resistance to the rotation of the inner rotating ring 6 with respect to the timepiece case 2.

The gasket 17 is in close contact with the bezel 12 and the inner rotating ring 6 over the entire circumference. According to this configuration, since frictional resistance is generated between the gasket 17 and the bezel 12 and between the gasket 17 and the inner rotating ring 6, the gasket 17 can be a resistance member that applies the frictional resistance to the rotation of the inner rotating ring 6 with respect to the timepiece case 2.

The rotation restriction protrusion 57 of the movable ring 56 can abut the step portion 38 of the shaft portion 36 from the outer side in the axial direction. Accordingly, the movable ring 56 is prevented from falling off from the shaft portion 36 to the inner side in the axial direction. In this configuration, in a state where the shaft portion 36 is inserted into each of the movable ring 56, the coil spring 61, and the washer 63, the shaft portion 36 is screwed to the head portion 31, and the rotation operation portion 30, the movable ring 56, the coil spring 61, and the washer 63 can be unitized. Therefore, the timepiece 1 can have excellent maintainability.

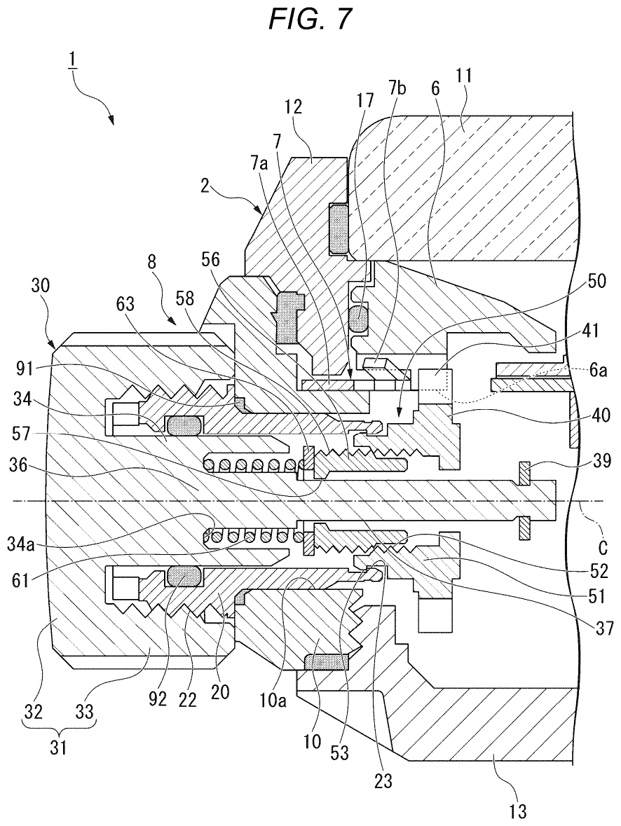

Although the shaft portion 36 is screwed to the head portion 31 in the rotation operation portion 30 in the first embodiment, the present disclosure is not limited to this configuration. That is, as illustrated in FIG. 7, the head portion 31 and the shaft portion 36 may be integrally formed. Accordingly, the number of components can be reduced as compared with a configuration in which the shaft portion and the head portion are provided as separate members. Further, since loosening of the screwing between the shaft portion 36 and the head portion 31 due to the rotation operation of the rotation operation portion 30 does not occur, it is possible to obtain a timepiece having excellent durability. When the head portion 31 and the shaft portion 36 are integrally formed, it is desirable that the flat surface portion 37 of the shaft portion 36 is extended to a tip end portion of the shaft portion 36 and the shaft portion 36 can be inserted into the movable ring 56 and the like from the outer side in the axial direction.

Although the engagement gear 40 is screwed to the driving ring 51 in the first embodiment, the present disclosure is not limited to this configuration. It is sufficient that the engagement gear and the driving ring rotate in synchronization with each other. For example, as illustrated in FIG. 7, the engagement gear 40 and the driving ring 51 may be integrally formed.

Although the support cylinder 20 is screwed to the case main body 10 in the first embodiment, the present disclosure is not limited to this configuration. It is sufficient that the support cylinder 20 is fixed to the timepiece case 2. For example, as illustrated in FIG. 7, the support cylinder 20 may be fixed to the timepiece case 2 by brazing or the like.

### Second Embodiment

A second embodiment is different from the first embodiment in that a driving ring 151 and a movable ring 156 of a rotation transmission portion 150 are engaged with a ratchet. Configurations other than those to be described below are similar to those of the first embodiment.

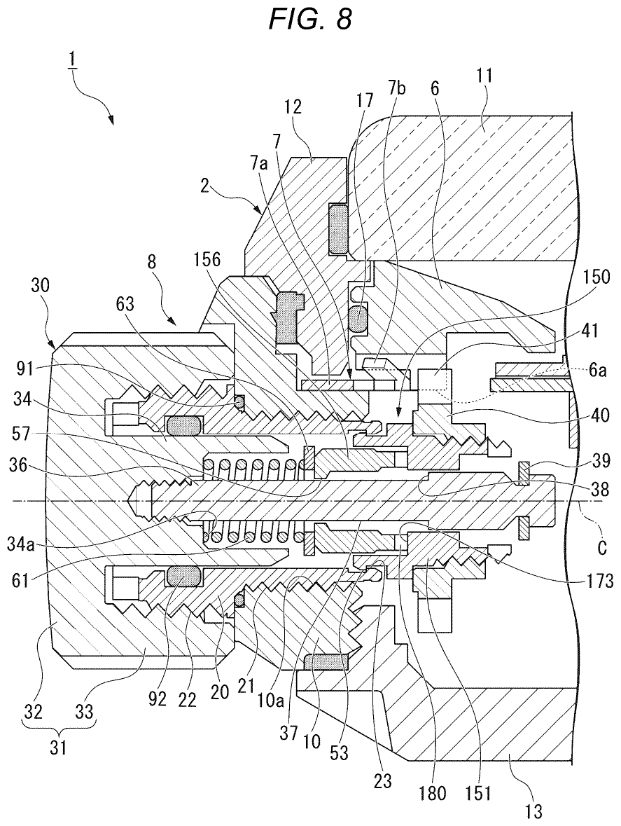

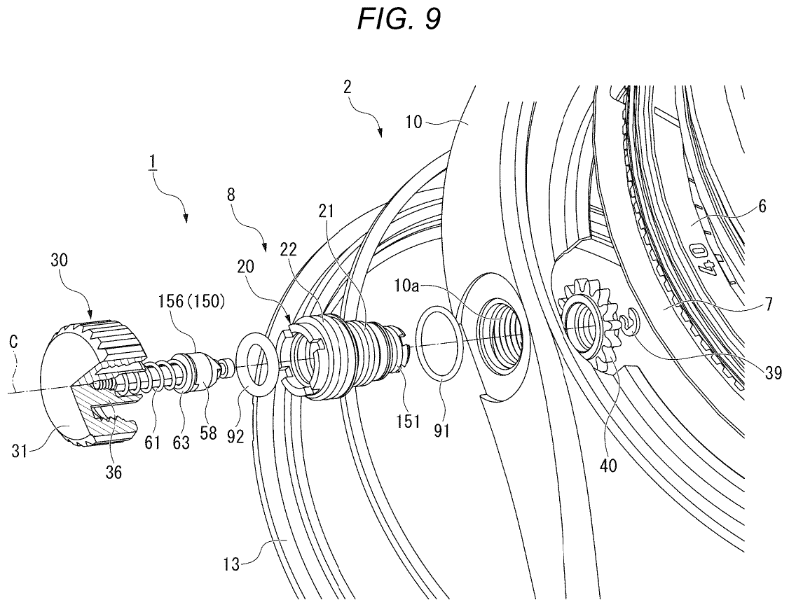

FIG. 8 is a cross-sectional view illustrating a part of a timepiece according to a second embodiment and corresponds to FIG. 3. FIG. 9 is an exploded perspective view illustrating a part of the timepiece according to the second embodiment.

As illustrated in FIGS. 8 and 9, the ring driving portion 8 includes the rotation transmission portion 150 instead of the rotation transmission portion 50 of the first embodiment. The rotation transmission portion 150 includes the driving ring 151, the movable ring 156, the coil spring 61, and the washer 63.

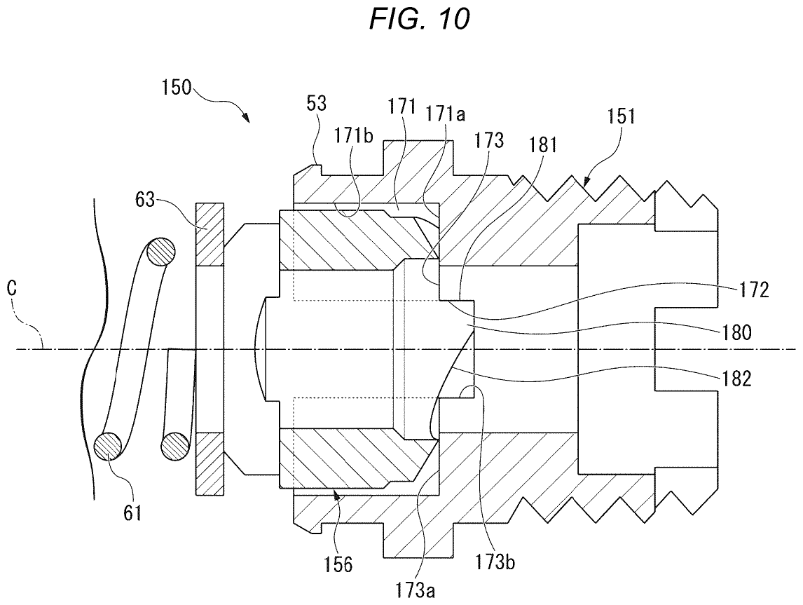

FIG. 10 is a longitudinal cross-sectional view of a rotation transmission portion of the second embodiment.

As illustrated in FIG. 10, the driving ring 151 is formed in a cylindrical shape. The driving ring 151 includes a recessed portion 171 that opens outward in the axial direction and a slit 172 that is formed at an axially outer end portion. The recessed portion 171 is formed in a circular shape centered on the axis C when viewed from the axial direction, and is formed so as to enlarge an inner diameter of the driving ring 151. The recessed portion 171 is defined by a bottom surface 171a in a circular ring shape facing outward in the axial direction and an inner peripheral surface 171b extending in the axial direction. The slit 172 is cut axially inward from an axially outer end edge of the driving ring 151. A plurality of (two in the embodiment) slits 172 are formed at equal intervals in the second circumferential direction. Each slit 172 has a fixed width in the second circumferential direction. The slit 172 is cut to a position on the inner side in the axial direction with respect to the bottom surface 171a of the recessed portion 171.

The driving ring 151 includes a driving-side protrusion (first engagement portion) 173 protruding toward the movable ring 156 (outward in the axial direction). The driving-side protrusion 173 is a part sandwiched by the slits 172 from both sides in the second circumferential direction. A plurality of (two in the embodiment) driving-side protrusions 173 are arranged at intervals in the second circumferential direction. The driving-side protrusion 173 has a top surface 173a facing outward in the axial direction and a pair of side surfaces 173b facing the second circumferential direction. The top surface 173a is the bottom surface 171a of the recessed portion 171. The side surface 173b is a side surface of the slit 172. The pair of side surfaces 173b extend along the axial direction.

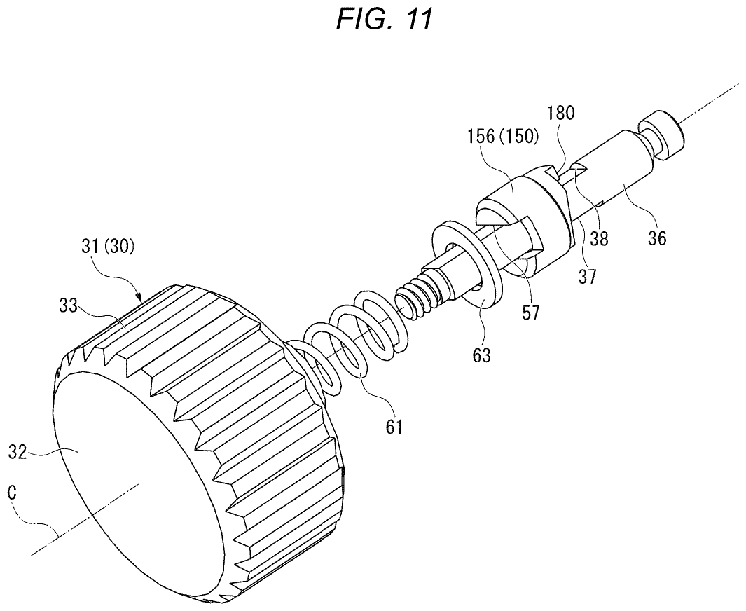

FIG. 11 is an exploded perspective view illustrating a part of the ring driving portion according to the second embodiment.

As illustrated in FIGS. 10 and 11, the movable ring 156 is formed in a cylindrical shape. The movable ring 156 is disposed on the outer side (outer side in the axial direction) of the case main body 10 with respect to the driving ring 151. An axially inner end portion of the movable ring 156 is inserted into the recessed portion 171 of the driving ring 151. The axially inner end portion of the movable ring 156 faces the driving-side protrusion 173 in the axial direction. The axially inner end portion of the movable ring 156 has a movable-side protrusion (second engagement portion) 180 protruding toward the driving ring 151. A plurality of (two in the embodiment) movable-side protrusions 180 are arranged at intervals in the second circumferential direction. The movable-side protrusion 180 enters a gap between the driving-side protrusions 173 adjacent to each other in the second circumferential direction. The movable-side protrusion 180 is detachably engaged with the driving-side protrusion 173. The movable-side protrusion 180 includes an engagement surface 181 facing a clockwise direction and an inclined surface 182 facing a counterclockwise direction and the inner side in the axial direction. The engagement surface 181 extends along the axial direction. The engagement surface 181 faces, in the second circumferential direction, the side surface 173b of the driving-side protrusion 173 facing the counterclockwise direction. The inclined surface 182 extends inward in the axial direction toward the clockwise direction. The inclined surface 182 faces, in the second circumferential direction, the side surface 173b of the driving-side protrusion 173 facing the clockwise direction. The inclined surface 182 is in sliding contact with the driving-side protrusion 173.

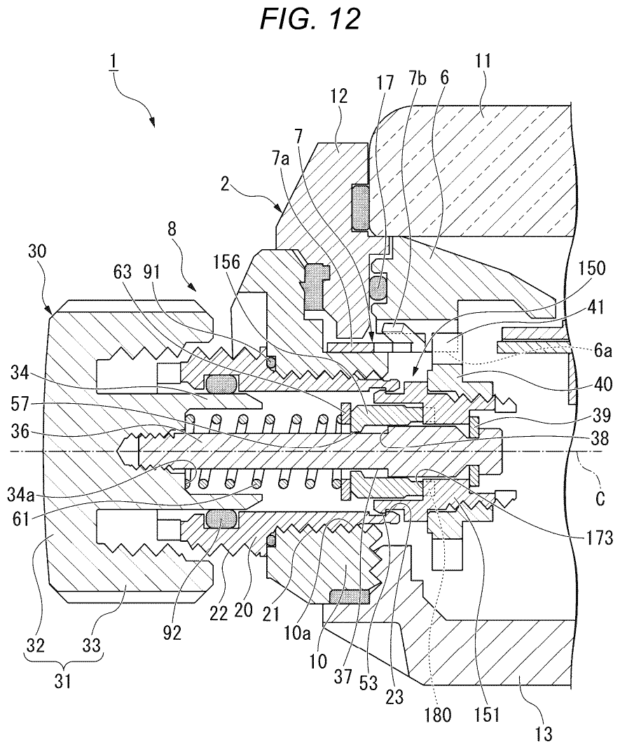

An operation of the timepiece 1 according to the embodiment will be described with reference to FIGS. 8, 10 and 12. FIG. 12 is a cross-sectional view of the timepiece according to the second embodiment and corresponds to FIG. 8. FIG. 8 illustrates a state in which the rotation operation portion 30 is at the push-in position, and FIG. 12 illustrates a state in which the rotation operation portion 30 is at the pull-out position.

When the rotation operation portion 30 at the push-in position is rotated clockwise, the screwing of the head portion 31 and the support cylinder 20 is loosened, and the head portion 31 is detached from the support cylinder 20 and moves to the pull-out position. When the rotation operation portion 30 is rotated clockwise and a clockwise torque is input to the movable ring 156, the engagement surface 181 of the movable-side protrusion 180 and the side surface 173b of the driving-side protrusion 173 abut each other, so that the movable-side protrusion 180 and the driving-side protrusion 173 are engaged with each other, and clockwise rotation of the movable ring 156 is transmitted to the driving ring 151. As a result, the driving ring 151 rotates clockwise integrally with the movable ring 156. When the driving ring 151 rotates clockwise, the engagement gear 40 fixed to the driving ring 151 also rotates clockwise, and further the inner rotating ring 6 rotates counterclockwise. Therefore, when the rotation operation portion 30 is rotated clockwise, the torque is transmitted to the inner rotating ring 6 through the rotation transmission portion 150 and the engagement gear 40, and the inner rotating ring 6 rotates counterclockwise.

When the rotation operation portion 30 at the pull-out position is rotated counterclockwise while being pushed inward in the axial direction, the head portion 31 is screwed into the support cylinder 20 and moves to the push-in position. When the rotation operation portion 30 is rotated counterclockwise, the movable ring 156 is also rotated counterclockwise. Since the rotation of the inner rotating ring 6 in the clockwise direction is restricted, the rotation of the driving ring 151 in the counterclockwise direction is restricted. Therefore, when a counterclockwise torque is input to the movable ring 156, while the movable ring 156 rotates counterclockwise with respect to the driving ring 151, the movable ring 156 slides the inclined surface 182 of the movable-side protrusion 180 on the driving-side protrusion 173, is displaced outward in the axial direction with respect to the driving ring 151, and rides on the top surface 173a of the driving-side protrusion 173. Accordingly, the movable-side protrusion 180 is detached from the driving-side protrusion 173. In a state where the movable-side protrusion 180 rides on the top surface 173a of the driving-side protrusion 173, the movable ring 156 can rotate in both directions with respect to the driving ring 151, and even when the counterclockwise rotation is continued or the rotation direction is switched to the clockwise direction, the movable ring 156 receives a biasing force of the coil spring 61 and enters the gap between the driving-side protrusions 173 again. As a result, the movable ring 156 can continue to rotate counterclockwise and cannot rotate clockwise with respect to the driving ring 151. Therefore, the rotation operation portion 30 idles counterclockwise with respect to the engagement gear 40 without rotating the inner rotating ring 6.

As described above, the rotation transmission portion 150 transmits the clockwise rotation of the rotation operation portion 30 to the engagement gear 40, and causes the rotation operation portion 30 to idle counterclockwise without rotating the engagement gear 40. As a result, in the timepiece 1 according to the embodiment, only the torque in one direction (clockwise direction) of the rotation operation portion 30 is transmitted to the inner rotating ring 6, and the inner rotating ring 6 can be rotated only counterclockwise.

In the embodiment, the following functions and effects are achieved. The driving ring 151 includes the driving-side protrusion 173 facing the movable ring 156 in the axial direction. The movable ring 156 includes the movable-side protrusion 180 that detachably engages with the driving-side protrusion 173. The driving-side protrusion 173 and the movable-side protrusion 180 transmit the clockwise rotation of the movable ring 156 to the driving ring 151 when engaged with each other, and are detached from each other by receiving the counterclockwise rotation of the movable ring 156 with respect to the driving ring 151. According to this configuration, the movable ring 156 can rotate integrally with the driving ring 151 when rotating clockwise, and rotates counterclockwise with respect to the driving ring 151 when rotating counterclockwise. Therefore, in the embodiment, effects similar to those of the first embodiment are achieved.

The invention is not limited to the embodiments described above with reference to the drawings, and various modifications are conceivable within the technical scope of the invention.

For example, in the above-described embodiments, the movable rings 56 and 156 are integrally rotatable with the rotation operation portion 30 regardless of the position in the axial direction of the rotation operation portion 30. However, the movable ring may be configured to be integrally rotatable with the rotation operation portion only when the rotation operation portion is at the pull-out position, and to idle with respect to the movable ring when the rotation operation portion is at the push-in position.

Although the head portion 31 of the rotation operation portion 30 is screwed to the timepiece case 2 in the above-described embodiments, the present disclosure is not limited to this configuration. The rotation operation portion may be movable in the axial direction between the push-in position and the pull-out position without being rotated.

The rotation operation portion 30 is movable between the push-in position and the pull-out position in the above-described embodiments. However, the rotation operation portion may be immovable in the axial direction.

In addition, the components in the above-described embodiments can be appropriately replaced with well-known components without departing from the gist of the invention, and the above-described embodiments and modifications may be appropriately combined.

What is claimed is:

1. A timepiece comprising:
a case;
an inner rotating ring that is accommodated in the case and that is rotatable in a circumferential direction;
an engagement gear that is engaged with the inner rotating ring and that rotates in synchronization with the inner rotating ring;
a rotation operation portion that includes a head portion disposed outside the case and that is provided to be rotatable about an axis with respect to the case; and
a rotation transmission portion that transmits rotation of the rotation operation portion in a first direction to the engagement gear and that causes the rotation operation portion to idle in a second direction.

2. The timepiece according to claim 1, wherein
the rotation transmission portion includes
a driving ring that rotates in synchronization with the engagement gear about the axis, and
a movable ring that is integrally rotatable with the rotation operation portion about the axis, that is integrally rotatable with the driving ring when rotating in the first direction, and that rotates in the second direction with respect to the driving ring when rotating in the second direction.

3. The timepiece according to claim 2, wherein
the driving ring and the movable ring are screwable to each other, and
the movable ring is screwed to the driving ring by rotating in the first direction with respect to the driving ring and then is not rotatable in the first direction with respect to the driving ring, and is detached from the driving ring by rotating in the second direction with respect to the driving ring and then is rotatable in the second direction with respect to the driving ring.

4. The timepiece according to claim 2, wherein
the driving ring includes a first engagement portion facing the movable ring in an axial direction of the axis,
the movable ring includes a second engagement portion detachably engaged with the first engagement portion, and
the first engagement portion and the second engagement portion transmit rotation of the movable ring in the first direction to the driving ring when engaged with each other, and are detached from each other by receiving rotation of the movable ring in the second direction with respect to the driving ring.

5. The timepiece according to claim 1, further comprising:
a thread portion that is disposed outside the case and that is fixed to the case, wherein
the head portion is screwed to the thread portion and is detached from the thread portion by rotating in the first direction with respect to the case.

6. The timepiece according to claim 1, further comprising:
a resistance member that comes into sliding contact with the inner rotating ring to apply resistance to rotation of the inner rotating ring with respect to the case.

7. The timepiece according to claim 6, wherein
the inner rotating ring is formed with a plurality of recesses and projections arranged in the circumferential direction, and
the resistance member is engaged with and disengaged from the recess and projection while being elastically deformed.

8. The timepiece according to claim 6, wherein
the case includes a facing portion that faces the inner rotating ring over the entire circumferential direction, and
the resistance member is a gasket that is in close contact with the facing portion and the inner rotating ring over an entire circumference.

9. The timepiece according to claim 1, wherein
the rotation operation portion includes a shaft portion that extends from the head portion toward an inside of the case and that engages with the rotation transmission portion, and
the shaft portion and the head portion are integrally formed.
